(19) United States
(12) Patent Application Publication
(10) Pub. No.: US 2003/0033215 A1
(43) Pub. Date: Feb. 13, 2003

(54) Business process modeling of wholesale procurement

(76) Inventors: Halim Habiby, Los Gatos, CA (US); Kamran J. Haq, New York, NY (US); William A. Hurley, Lexington, KY (US); Richard Scott, Daly City, CA (US); Marie Joelle Simonpietri, Honolulu, HI (US)

Correspondence Address: Philip M. Weiss, WEISS & WEISS, 500 OLD COUNTRY ROAD, GARDEN CITY, NY, 11530, US

(21) Appl. No.: 10/205,337

(22) Filed: Jul. 25, 2002

Related U.S. Application Data
(60) Provisional application No. 60/307,896, filed on Jul. 26, 2001.

(51) Int. Cl. G06F 17/60

(52) U.S. Cl. 705/26

(57) ABSTRACT

A system for transacting business between wholesalers, distributors and their customers.

### FIELD OF THE INVENTION

The present invention relates to software for wholesalers, distributors and their customers when transacting business.

### BACKGROUND OF THE INVENTION

Wholesale distribution is a selling practice often adopted by industries in which manufacturing companies do not have the capacity, capability, geographic presence, or expertise to sell their products directly to end users. It may also be employed by selling companies that have the means to purchase large quantities of goods from manufacturers at discounted prices and in turn pass discounts on to their buying customers. Many manufacturing companies focus their resources on product development and production instead of distribution, and they rely on various wholesale distribution arms to disseminate their products into public markets.

Typically wholesalers and distributors are companies that are independent of the manufacturers whose products they sell. A distributor may operate out of a single location or have multiple branches across a wide geographic area. Wholesalers and distributors purchase and resell goods produced by a number of manufacturers. They usually maintain warehouses and product inventories and offer a variety of services to their customers, such as credit terms, individualized pricing, catalog purchasing services, warranties and timely delivery. They rely heavily on repeat business from customers with whom they hold long-standing relationships.

Buying companies who purchase goods from wholesalers and distributors typically rely on the same distributors on a repeat basis. Buyers hold long-standing relationships with their distributors, who extend to them a variety of services, such as credit terms, individualized pricing, catalog purchasing services, warranties and timely delivery.

Relationships between sellers (wholesalers and distributors) and buyers are built over a period of time, often many years, and have several aspects to them. Loyalty between the parties develops as a consequence of discounted and individualized pricing, credit terms, delivery options, stock availability, honoring warranties and returns, responsiveness and customer service.

Over the past several years, there has been an explosion of computer usage connected to the global Internet and the World wide web. This increase in connectivity has allowed computer users to access various types of information, disseminate information, and be exposed to electronic commerce activities, all with a great degree of freedom. Electronic commerce includes large corporations, small businesses, individual entrepreneurs, organizations and the like, who offer their information, products, and/or services to people all over the world via the Internet.

Because product distributors typically sell goods from multiple manufacturers, each distributor will typically develop its own catalog of products using the information provided by a variety of manufacturers. As a result, updated product information received from a manufacturer is not easily disseminated to retailers and other buying customers who purchase products from wholesalers and distributors.

Traditionally, wholesale procurement practices have been manual, labor intensive, predominantly paper-based, and costly. For example, a distributor might perform mass mailings of its printed catalogs to potential customers. Customers might then browse the catalogs and select items of interest; customers might research their product selections by contacting manufacturers or burdening a wholesaler with questions about technical specifications, product availability, aesthetic qualities, compatibility, installation, optional and required parts and accessories, maintenance and warranties. Finally, to make a purchase a customer would complete paper order forms or call the distributor by phone or make a personal visit to place an order. Buyer and seller would haggle over pricing and delivery until agreeable terms are found. The entire process, from preparation of the catalogs to receipt and fulfillment of the orders is costly and wrought with inefficiencies and wasted time and resources.

U.S. Pat. Nos. 6,115,641, 6,115,642 and 5,923,552 relate to systems, methods and computer program products which synchronize product fabrication schedules with supplier schedules. A fabrication schedule is obtained from a fabricator data processing system, and supplier schedules are obtained from respective supplier data processing systems. Restrictive links are established between the fabrication schedule and the supplier schedules. Each restrictive link defines the supplier that will perform a work stage, and can also define the starting and ending times for both fabrication and supplier schedules. Float time preceding a selected activity starting time is assigned and utilized to absorb delays in completing activities preceding the selected activity. A computer based product catalog system automatically distributes and updates product information.

### SUMMARY OF THE INVENTION

The present invention provides software that emulates and enhances the practices employed by wholesalers, distributors, and their customers when transacting business. Its applications can be used by parties who are involved in the wholesale distribution, selection, procurement, and installation of various families of products.

It is an object of the present invention to provide software for, but not limited to:

Plumbing fixtures, valves, pipe and tubing;

Heating, ventilation and air conditioning (HVAC);

Construction machinery and equipment;

Metalworking machinery and equipment;

Farm machinery and equipment;

Refrigeration machinery and equipment;

Electrical equipment and products;

Electronic equipment and products;

Household appliances;

Commercial appliances;

Medical Instruments and devices;

Photographic and video recording equipment;

Automotive parts and equipment;

Aircraft parts and equipment;

Ship and boat building parts and equipment;

Railroad and mass transit equipment;

Engines and turbines;

General industrial machinery;

Lumber and wood products;

Prefabricated construction materials;

Furniture and fixtures;

Fabricated rubbers and plastics;

Stone, clay and glass products;

Iron and steel foundries and furnaces;

Nonferrous metal casting, rolling and drawing; and

Fabricated metal products.

The present invention provides Internet based software to wholesalers and distributors that aggregates detailed product information from multiple manufacturers and maintains it in a proprietary database. The product data is acquired from manufacturers on a periodic basis and kept current in a master database. The data is then made available to wholesalers and distributors and their buying customers through customized, branded Internet web sites on behalf of wholesalers and distributors. As a result, wholesalers and distributors may conduct electronic commerce through their own web sites that offer detailed information about the products that they each carry. This detailed information is retrieved from the master database of product information.

It is an object of the present invention to offer complete electronic commerce wholesale sales and procurement services. These services encompass all of the steps involved in wholesale sales and procurement. It is an object of the present invention to aggregate detailed product data on a periodic basis from multiple manufacturers into a standardized proprietary database. It is an object of the present invention to disseminate such product data via branded wholesaler and distributor Internet web sites to their buying customers. It is an object of the present invention to allow buying customers to search through a wholesaler's or distributor's product set via the Internet according to engineering specifications and technical criteria, as well as aesthetic qualities, pricing and other attributes. It is a further object of the invention to allow buying customers to narrow product choices quickly and make decisions to purchase specific items. It is an object of the present invention to allow buying customers to purchase products that are compatible with each other.

It is an object of the present invention to allow buying customers to easily select and order required and optional parts and accessories related to a specific product. It is an object of the present invention to allow buying customers to manage multiple procurement projects via a wholesaler or distributor web site, each project containing a number of products to be purchased, priced or delivered. It is an object of the present invention to allow wholesalers and distributors to manage and maintain individual prices on a customer-by customer or item-by-item basis.

It is an object of the present invention to allow buying customers to submit specific products through a request for quotation (RFQ) to the wholesaler or distributor for quotation and price negotiation. It is an object of the present invention to allow wholesalers and distributors to receive RFQs and engage in price negotiation, or haggling with customers, electronically, until a mutually agreeable price is found. It is an object of the present invention to allow wholesalers and distributors to easily substitute one product for another in a submitted RFQ. It is an object of the present invention to allow wholesalers and distributors and their customers to converse and negotiate electronically while maintaining a recorded history of each conversation or negotiation. It is an object of the present invention to allow buying customers to submit specific products for purchase and ordering once mutually agreeable pricing terms are found. It is an object of the present invention to allow buying customers to specify shipping and billing information, as well as specific instructions, if any, on an item-by-item basis to the wholesaler or distributor. It is an object of the present invention to allow wholesalers and distributors to receive electronic orders and manage the status of orders through multiple stages until they are fulfilled.

### BRIEF DESCRIPTION OF DRAWINGS

FIG. 1 illustrates a distribution chain of the present invention.

### DETAILED DESCRIPTION OF THE INVENTION

The present invention provides the steps for wholesale sales and procurement.

Parametric Cataloging

Sellers, for example, are wholesalers and distributors that purchase and resell manufactured goods to contractors and sub-contractors who build complex systems in construction projects. Buyers, for example, are builders, including specialized contractors, such as plumbing sub-contractors who purchase and install complex systems for commercial and residential structures. Specifying engineers, for example, design structures and are often responsible for selection of the mechanical components, such as plumbing and heating products, to be installed within them. Product manufacturers, for example, are manufacturers who produce goods but do not sell them directly to contractors and builders. Rather, they rely on wholesalers and distributors as their distribution arms. Manufacturers produce product literature and specification data that are heavily relied upon by Buyers and Specifying Engineers.

Many industries are built upon a broad base of products with complex attributes and rules that govern product relationships and interdependencies. The present invention builds standardized, parameterized, and proprietary master catalogs for various industries and spools out customized versions to participants in those industries. Some tailored catalogs may be built from start to finish for particular customers as well.

Parametric Attribute Search

This allows users to conduct fast, cross-manufacturer searches of products based on relevant engineering specifications and technical criteria, as well as aesthetic qualities, pricing, and other attributes. This type of search is especially effective for complex products, which are represented by multiple engineering parameters, or attributes. Some examples of parameters include but are not limited to dimension, flow rate, finish, mount type, capacity, valve construction, building code compliance, color, weight and price. One user of the parametric attribute search is the specifying engineer, who may utilize the present invention's parameterized master catalog for product searches and specification during the design phase of a project. Another user is the buying customer who makes purchasing decisions and places orders through its wholesaler or distributor web site.

Compatibility Checking (Inter-Object Configuration Logic)

This allows users to select products that, when installed, are compatible with each other. Some examples in the plumbing industry may include whether a particular water faucet and sink will fit together when installed, or whether a shower enclosure and a drain will fit together. Furthermore, items that require the purchase of other items will be denoted as such. Similarly, items for which a wholesaler or manufacturer recommends the purchase of other items will be denoted as such. Further, optional accessories will be shown and denoted as such.

Related Item Search (Inter-Object Configuration Logic)

Many products have relationships and dependencies among each other. For example, in the plumbing industry, a certain type of lavatory sink may only be compatible with a particular set of faucets. A shower enclosure may only be compatible with a particular set of drains. The present invention enforces and supports the industry specific rules and logic that govern product relationships. The present invention easily allows users to find compatible, related products that will fit together regardless of the manufacturers who produced them.

Procurement Project Management

Users can manage multiple procurement projects through the present invention. They can bundle their selected products into logical purchasing groups and pay for them and schedule them for delivery as required. They can accept the given list price, the discounted trade price, or the negotiated individualized contract price offered by the wholesaler or distributor. Alternatively, they can interact electronically with the wholesaler or distributor through custom Request for Quote (RFQ) functionality until an agreeable price is reached.

Request for Quotation and Price Haggling

A buying customer who wishes to negotiate an alternate price to the trade or contract price, or in the absence of any discounted trade or contract price, may create an interactive RFQ and engage in electronic price negotiation, or haggling, with a wholesaler or distributor until a mutually agreeable price is found. When responding to an RFQ a wholesaler or distributor may quote individual product line terms to the buyer, or the wholesaler or distributor may provide one price quote for all the items together, with the quoted price contingent on the purchase price of all items at hand. Electronic messages between the buyer and seller are also stored in the RFQ, along with a versioned history of the quotation.

Product Substitution

When responding to an RFQ a wholesaler or distributor can substitute an equivalent product to one that the buyer is requesting. Substitutions are often used to bring a price down with a similar product to one that a buyer has requested. The present invention facilitates substitutions by allowing a quick search for a substitute item and easy replacement into the quotation.

Contract Pricing

The present invention provides individualized pricing for its users. A wholesaler or distributor and buyer may negotiate contractual pricing that is honored specifically for that buyer and no other party. In addition, the contractual pricing may be set up for particular items or SKUs, that a buyer purchases frequently. As a result, each buyer may have a unique pricing structure for the items they purchase. The prices themselves are part of the product information and are searchable as well.

Order Transmission

Once a group of products is ready for purchase within a procurement project, and once all the pricing is agreed upon, an order may be generated and transmitted to a wholesaler or distributor.

Design Sharing

Using product substitution, unrelated parties may collaborate on particular product choices. For example, an architect or specifying engineer may utilize the parametrized master catalog to conduct product searches and narrow down product choices that are in turn stored in a Procurement project. This project may be forwarded electronically to another party, such as a buying organization responsible for goods procurement and installation. The receiving party, a buying organization, may need to substitute one or more products due to a long delivery lead time or other reasons, such as cost reduction. The parties engaged in product selection and procurement may engage in electronic sharing of their choices until mutually agreeable products are found.

Many manufacturing companies focus their resources on product development and production instead of distribution, and they rely on various wholesale distribution arms to disseminate their products into public markets.

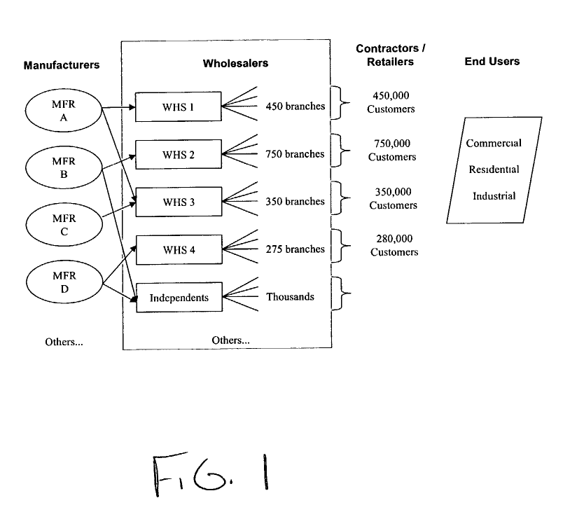

In FIG. 1, manufacturers A, B, and D distribute their products through one or more wholesale distributors. For example, manufacturer A (MFR A) distributes its products through Wholesaler 1 (WHS 1) and Wholesaler 3 (WHS 3). Manufacturer C (MFR C) distributes its products exclusively through Wholesaler 3 (WHS 3).

Wholesalers WHS 1, WHS 2, WHS 3, and WHS 4 represent large companies that operate multiple branches across geographic areas. While independent wholesalers are typically smaller, all wholesale distribution companies range from a single branch to hundreds of branch locations across geographic areas.

Wholesale branches maintain their own relationships with local and regional customers. They typically maintain warehouses and product inventories and offer a variety of services to their customers, such as credit terms, individualized pricing, catalog purchasing services, warranties and timely delivery. They rely heavily on repeat business from customers with whom they hold long-standing relationships.

Wholesale branches sell to customers who are involved in the selection, procurement, resale, installation, or repair of various families of products.

### EXAMPLE I

Following is a scenario detailing a business transaction between a wholesale distributor and its buying customer.

| | Manu- | | | |
|---|---|---|---|---|
| Wholesale | facturers | Product | | Customer |
| Distributor | Carried | Lines | Customer | Interest |
| WHS 3 | MFR A | Plumbing | Mechanical | Bath Tubs for |
| | MFR C | fixtures, valves, | Contractor | Urban Hotel |
| | | pipe, and tubing. | (MC) | |

A mechanical contracting firm (MC) has been awarded a job to replace the bath tubs in a large hotel. MC has an existing relationship with wholesale distributor WHS 3. The two parties are accustomed to transacting business between each other; however, MC is not obligated to procure its materials from WHS 3.

MC accesses a web site for WHS 3 via the Internet and is able to create a new project (“Urban Hotel Project”). The WHS 3 web site is operated by software of the present invention that emulates and enhances the practices employed by wholesalers, distributors, and their customers when transacting business. When MC access the WHS 3 web site MC identifies itself to WHS 3 via a unique login ID and password.

MC is able to view the Urban Hotel Project along with a series of other projects that MC has worked on in the past or is presently working on. MC decides to search for bath tubs that are carried by WHS 3.

MC inputs a series of search criteria into available fields on the WHS 3 web site. MC specifies a number of engineering criteria to meet the specifications of the Urban Hotel Project. For the bath tubs, MC specifies the following criteria:

Bath tub length: 5′

Bath tub material: acrylic

Bath tub drain location: right

Bath tub color: white

Bath tub ADA (Americans with Disabilities Act) compliance

Bath tub price range: less than $500

MC views a list of bath tubs that meet its criteria and that are carried or available for purchase through WHS 3. Included in the list are bath tubs made by multiple manufacturers. The list of bath tubs and their technical specifications is extracted from a standardized database containing product information from multiple manufacturers.

MC recognizes a model it has purchased in the past and selects that model for the Urban Hotel Project. MC is presented with a list of optional accessories for the bath tubs, such as compatible drains and plastic handlebars. MC elects to purchase only the bath tubs, adds them to the Urban Hotel Project, and specifies a quantity of 150 bath tubs.

Because MC has already identified itself to WHS 3 electronically via its unique login ID and password, and because MC is a frequent, high-volume customer of WHS 3, the pricing information displayed to MC is discounted and based on a price list for frequent, high-volume customers. Nonetheless, MC is not completely satisfied with the final price for 150 bath tubs. MC elects to request a price quote from WHS 3.

MC fills in a series of fields related to a Request for Quotation (“RFQ”) for WHS 3. Once the RFQ is electronically submitted to WHS 3, WHS 3 reviews the request for the model and quantity of the bath tubs that MC has selected. WHS 3 can offer MC a further discount to the price MC has already seen.

MC and WHS 3 can negotiate repeatedly over a number of hours or days, via the WHS 3 web site, as the RFQ is reviewed and forwarded between the two parties. A complete message and pricing history related to the RFQ is also maintained and saved. During this period or at any time MC may access any of the projects it has created on the WHS 3 web site. At any time MC may accept or decline the latest price quotation offered by WHS 3.

If and when a mutually agreeable price is reached for the bath tubs, the RFQ is accepted and automatically reissued as a definitive order and forwarded to WHS 3 for fulfillment. At any time WHS 3 may update the status of this order, and at any time MC may check the status of this order via the WHS 3 web site.

Once the order has been fulfilled or at any time prior or thereafter, MC will be able to view this order and the Urban Hotel Project via the WHS 3 web site. Once the order has been fulfilled, future orders and quotations may also be placed for the same project. For example, if MC requires new drains to install on each bath tub, MC may at any time return to its Urban Hotel Project and the bath tubs order contained within it. MC can re-identify the optional compatible drains for the bath tubs and elect to place an order for the drains.

### EXAMPLE II

Following is a scenario detailing a business transaction between a wholesale distributor and its buying customer.

| | Manu- | | | |
|---|---|---|---|---|
| Wholesale | facturers | Product | | Customer |
| Distributor | Carried | Lines | Customer | Interest |
| WHS 3 | MFR A | Plumbing | Mechanical | Sinks and |
| | MFR C | fixtures, valves, | Contractor | Faucets for |
| | | pipe, and tubing. | (MC) | Urban Hotel |

A mechanical contracting firm (MC) has been awarded a job to replace the sinks and faucets in a large hotel. MC has an existing relationship with wholesale distributor WHS 3. The two parties are accustomed to transacting business between each other; however, MC is not obligated to procure its materials from WHS 3.

MC accesses a web site for WHS 3 via the Internet and is able to view an existing project (“Urban Hotel Project”) previously created via the same web site. The WHS 3 web site is operated by software of the present invention that emulates and enhances the practices employed by wholesalers, distributors, and their customers when transacting business. When MC access the WHS 3 web site MC identifies itself to WHS 3 via a unique login ID and password.

MC is able to view the Urban Hotel Project along with a series of other projects that MC has worked on in the past or is presently working on. MC first decides to search for lavatory sinks that are carried by WHS 3.

MC inputs a series of search criteria into available fields on the WHS 3 web site. MC specifies a number of engineering criteria to meet the specifications of the Urban Hotel Project. For the lavatory sinks, MC specifies the following criteria:

Lavatory basin shape: oval

Lavatory material: vitreous china

Lavatory mount/installation: undercounter

Lavatory color: white

Bath tub ADA (Americans with Disabilities Act) compliance

Lavatory price range: $100-$199

MC views a list of lavatory sinks that meet its criteria and that are carried or available for purchase through WHS 3. Included in the list are lavatories made by multiple manufacturers. The list of lavatories and their technical specifications is extracted from the database of the present invention containing product information from multiple manufacturers.

MC does not immediately decide on a specific model and elects to narrow its search further. MC enters an additional search criterion for the lavatory sinks:

Lavatory bowl depth: 5″ to 7″

Next MC sees a shorter, more manageable list of lavatory sinks and is better able to narrow its choices based on these new search results. MC remains undecided about its lavatory selection and decides to compare three lavatories to each other. MC selects three lavatories from the search results and views them in a side-by-side comparison. The three lavatories are made by different manufacturers, and they are represented in a standardized format for easy comparison by MC.

MC narrows its choice and selects one lavatory to view all published details pertaining to it. MC reviews the complete list of engineering specifications and all available variations and prices of this model.

Because MC has already identified itself to WHS 3 electronically via its unique login ID and password, and because MC is a frequent, high-volume customer of WHS 3, the pricing information displayed to MC is discounted and based on a price list for frequent, high-volume customers. MC adds the lavatory sink to the Urban Hotel Project and specifies a quantity of 150.

MC decides to find a lavatory faucet compatible with the lavatory sink recently selected. From the Urban Hotel Project, MC initiates a search for compatible faucets based on the context of the lavatory sink already selected. Because manufacturer data is stored in a standardized way and in a central database representing multiple manufacturers, the web site software of the present invention for WHS 3 is capable of matching products, such as lavatory sinks and faucets, that are compatible with one another based on predetermined compatibility criteria. Similarly, the web site software of the present invention can exclude products that are incompatible with each other.

In this case MC views a list of lavatory faucets that has already been filtered and narrowed to display only those models that are compatible with the lavatory sink already selected. MC selects a faucet model and views the complete list of engineering specifications and all available variations and prices for this model. MC is also presented with a list of optional and required accessories for this model. Even though MC is not bound to purchase a required accessory, MC understands that a required accessory, such as a faucet handle, will be needed at the time of installation. MC elects to view the list of faucet handles. MC selects one faucet handle and views its specifications and pricing details.

Because MC has already identified itself to WHS 3 electronically via its unique login ID and password, and because MC is a frequent, high-volume customer of WHS 3, the pricing information displayed to MC is discounted and based on a price list for frequent, high-volume customers. MC adds the lavatory faucets and handles to the Urban Hotel Project and specifies a quantity of 150 for each item.

MC reviews the Urban Hotel Project and believes that WHS 3 can improve its currently quoted price for the (yet unordered) lavatory sinks, faucets, and handles. MC elects to submit a Request for Quotation (“RFQ”) to WHS 3. MC fills in a series of fields related to the RFQ for WHS 3. Once the RFQ is electronically submitted to WHS 3, WHS 3 will review the request for the models and quantities of the sinks, faucets, and handles that MC has selected.

WHS 3 may offer MC a further discount to the price MC has already been quoted. WHS 3 may offer discounts based on each item, such as a 10% reduction on the lavatory sinks, a 5% reduction on the faucets, and no reduction on the faucet handles. Alternatively, WHS 3 may offer a package discount, such as a 15% reduction on the complete price of all the items combined and without creating individual line-item discounts.

MC and WHS 3 may negotiate repeatedly over a number of hours or days, via the WHS 3 web site, as the RFQ is reviewed and forwarded between the two parties. A complete message and pricing history related to the RFQ is also maintained and saved. During this period or at any time MC may access any of the projects it has created on the WHS 3 web site. At any time MC may accept or decline the latest price quotation offered by WHS 3.

If and when a mutually agreeable price is reached for the lavatory sinks, faucets, and handles, the RFQ is accepted and automatically reissued as a definitive order and forwarded to WHS 3 for fulfillment. At any time WHS 3 may update the status of this order, and at any time MC may check the status of this order via the WHS 3 web site.

Once the order has been fulfilled or at any time prior or thereafter, MC will be able to view this order and the Urban Hotel Project and its components via the WHS 3 web site. Once the order has been fulfilled, future orders and quotations may still be placed for the same project.

1. A system for purchasing products comprising:
a database comprising a list of products said products having complex attributes and rules that govern product relationships and interdependencies,

2. The system of claim 1 wherein said system generates standardized, parameterized, and proprietary master catalogs for various industries and spools out customized versions to participants in those industries.

3. The system of claim 1 wherein a user can search, through multiple manufacturers for products based on relevant engineering specifications and technical criteria, as well as aesthetic qualities, pricing, and other attributes.

4. The system of claim 3 wherein said attributes include but are not limited to dimension, flow rate, finish, mount type, capacity, valve construction, building code compliance, color, weight and price.

5. The system of claim 1 wherein said system allows a user to select products that, when installed, are compatible with each other.

6. The system of claim 1 wherein items that require the purchase of other items will be denoted as such.

7. The system of claim 1 wherein items for which a wholesaler or manufacturer recommends the purchase of other items will be denoted as such.

8. The system of claim 1 wherein optional accessories will be shown and denoted as such.

9. The system of claim 1 said system identifies products having relationships and dependencies among each other.

10. The system of claim 1 wherein said system allows users to find compatible, related products that will fit together regardless of manufacturers who produced them.

11. The system of claim 1 wherein said user can bundle selected products into logical purchasing groups and pay for them and schedule them for delivery as required.

12. The system of claim 1 wherein a user can accept a given list price, a discounted trade price, or a negotiated individualized contract price offered by a wholesaler or distributor.

13. The system of claim 1 wherein a buyer can interact electronically with a wholesaler or distributor through Request for Quote (RFQ) functionality until an agreeable price is reached.

14. The system of claim 13 wherein when responding to an RFQ a wholesaler or distributor may quote individual product line terms to said buyer, or said wholesaler or distributor may provide one price quote for all items together, with a quoted price contingent on purchase price of all items at hand.

15. The system of claim 14 wherein electronic messages between said buyer and said distributor are stored in said RFQ, along with a versioned history of said quotation.

16. The system of claim 13 wherein when responding to an RFQ a wholesaler or distributor can substitute an equivalent product to one that said buyer is requesting.

17. The system of claim 16 wherein said system facilitates substitutions by allowing a quick search for a substitute item and easy replacement into said quotation.

18. The system of claim 1 wherein said system provides individualized pricing for its users.

19. The system of claim 18 wherein a wholesaler or distributor and buyer may negotiate contractual pricing that is honored specifically for that buyer and no other party.

20. The system of claim 18 wherein contractual pricing may be set up for particular items or SKUs, that a buyer purchases frequently.

21. The system of claim 18 wherein each buyer has a unique pricing structure for items they purchase.

22. The system of claim 1 wherein prices are part of product information and are searchable.

23. The system of claim 1 wherein once a group of products is ready for purchase within a procurement project, and all pricing is agreed upon, an order is generated and transmitted to a wholesaler or distributor.

24. The system of claim 1 wherein said system allows a user to forward selections of products electronically to a second user for purchase.

25. The system of claim 24 wherein said second user can substitute one or more products to an order.

26. The system of claim 1 wherein information for said database is aggregated detailed product information from multiple manufacturers.

27. The system of claim 26 wherein said information is updated on a periodic basis.
